(19) United States
(12) Patent Application Publication
(10) Pub. No.: US 2004/0052293 A1
(43) Pub. Date: Mar. 18, 2004

(54) Monitoring thermal events

(76) Inventor: John David Sutherland, Poynton (GB)

Correspondence Address: NIXON & VANDERHYE, PC, 1100 N GLEBE ROAD, 8TH FLOOR, ARLINGTON, VA, 22201-4714, US

(21) Appl. No.: 10/343,683

(22) PCT Filed: Aug. 6, 2001
(86) PCT No.: PCT/GB01/03546

(30) Foreign Application Priority Data
Aug. 5, 2000 (GB) 0019176.7

(51) Int. Cl. G01K 1/00

(52) U.S. Cl. 374/100; 374/208

(57) ABSTRACT

Apparatus (2) for monitoring thermal events comprises an array of receptacles (4) for containing material to be monitored wherein each receptacle (4) is thermally isolated from each other receptacle. A respective thermistor (6) is provided in each receptacle and each thermistor is linked to a central control unit (10). The thermistors are used to monitor minute changes in temperature of materials within the receptacles. The apparatus may be used to monitor any process, whether physical or chemical, that involves a heat change.

This invention relates to the monitoring of thermal events and particularly, although not exclusively, relates to apparatus for monitoring a thermal event and a method relating to the same.

Combinatorial chemical techniques and parallel array techniques are used widely for generating large numbers of compounds or materials. However, less well-developed are apparatus and methods for rapid yet accurate testing of the compounds or materials generated. Consequently, whilst compounds or materials can be prepared rapidly using available techniques, screening and optimisation of the compounds or materials can be a slow step.

The present invention addresses the problem of monitoring thermal events to screen new compounds or materials.

There are many situations wherein heat is absorbed or evolved in chemistry for example in physical or chemical processes such as chemical reactions, interactions or transformations. The following are examples:

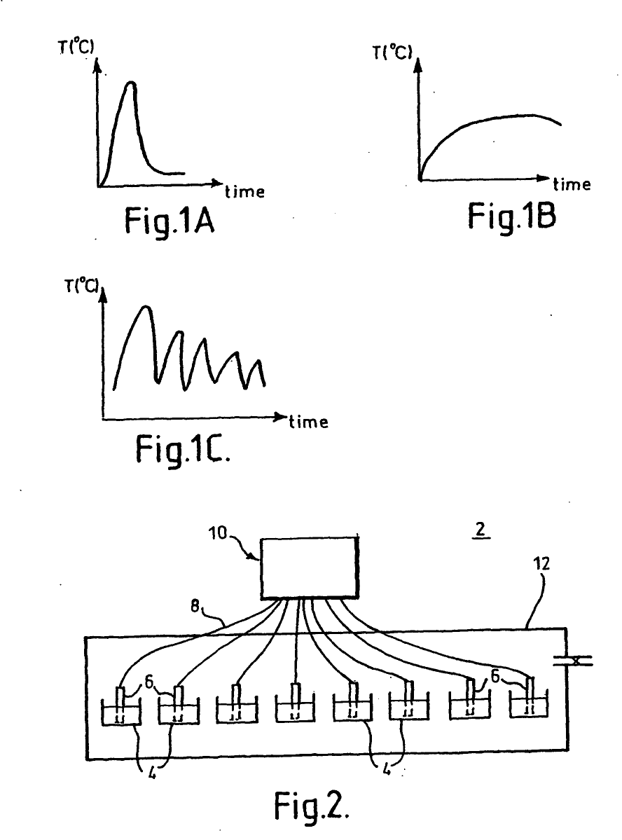

(i) In the polymerisation of ethylene, heat is evolved as the polymer is formed, causing a rise in temperature. A temperature versus time profile of the reaction will help to determine the catalyst mechanism used. Referring to FIG. 1 of the accompanying drawings, wherein temperature versus time profiles (A), (B) and (C) are shown for three catalysts, the activity of catalyst A rises quickly and falls off rapidly; the activity of catalyst B rises more slowly but falls off more slowly; and the activity of catalyst C rises and falls cyclically. It is highly desirable to be able to accurately assess temperature profiles and determine catalysts mechanisms. Such assessments may also yield data on the kinetics of polymerisation reactions.

(ii) In crystallisation reactions temperature can be extremely important. An awareness of temperature changes during a crystallisation may facilitate control and/or optimisation of the crystallisation.

(iii) As in (ii), the formation of polymorphs can involve complex heat and/or temperature, changes and details on these can aid subsequent preparation of a desired polymorph.

It is an object of the present invention to address problems relating to the monitoring of thermal events.

According to a first aspect of the invention, there is provided apparatus for monitoring thermal events, the apparatus comprising an array of regions, for example receptacles, for accommodating materials to be monitored, wherein a respective temperature monitoring means is associated with each receptacle.

Each said temperature monitoring means is preferably arranged to contact material to be monitored in a said region. Each said region may have an upper surface which is arranged to contact material to be monitored in use. Suitably, said temperature monitoring means is arranged to be positioned at a distance of less than 5 cm, preferably less than 4 cm, more preferably less than 3 cm, especially less than 2 cm from said surface. Where the apparatus includes an array of receptacles, each said temperature monitoring means is preferably arranged to be positioned at least partially within a liquid containing region of the receptacle, suitably below an uppermost surface thereof for contacting material within the receptacle in use. Thus, preferably, each said temperature monitoring means is arranged for the passage of heat from material accommodated in said region by conduction.

Preferably, each said temperature monitoring means is arranged to be moved between first and second positions, wherein, suitably, when in said first position, said temperature monitoring means are arranged to monitor temperature of material within said regions and, suitably, when in said second position, said temperature monitoring means are spaced further away from said regions and, therefore, suitably said second position represents a non-working position wherein temperature is not monitored. Preferably, the apparatus is arranged such that, with the temperature monitoring means in said second position, materials may be brought from outside the apparatus and positioned in said regions, for example prior to starting an experiment using the apparatus. The apparatus may be arranged to co-operate with, or may include, a robot for delivering materials to said regions.

Preferably a plurality, or more preferably all, of said temperature monitoring means are movable between first and second positions substantially concurrently. To this end, a plurality of temperature monitoring means may be fixed to a support structure which is movable thereby to move the temperature monitoring means as described. For example, said support structure may be pivotable for moving the temperature monitoring means.

Said array of regions may include any number of members. It suitably includes at least 10, preferably at least 30, more preferably at least 60, especially at least 90 members. The number of members is suitably less than 500, preferably less than 250, more preferably less than 150, especially less than 100. The number of temperature monitoring means of said apparatus is preferably at least equal to the number of regions in said array.

Said array of regions is preferably arranged within an enclosure, for example a box. Said apparatus preferably includes temperature control means for controlling the temperature within the enclosure. Said temperature control means preferably includes a heating means for raising the temperature within the enclosure. Said temperature control means may also include cooling means for lowering the temperature within the enclosure. The apparatus preferably includes means, for example a data processing unit, for storing information relating to the temperature within the enclosure, relative to time. Said data processing unit may also be arranged to adjust the temperature within the enclosure in a predetermined manner. Thus, by providing a temperature control means as described, the temperature(s) to which materials in said regions is/are subjected may be accurately controlled and monitored.

Each of said regions for accommodating material preferably includes an inlet/outlet for the material and preferably said inlets/outlets all face in substantially the same direction (e.g. upwards in use). A part of said enclosure which faces, and is suitably directly aligned with, said inlets/outlets may be non-transmissive of IR radiation; for example it may be substantially opaque.

Said apparatus preferably includes gas control means for controlling the supply of a gas into said enclosure. Suitably, therefore, said enclosure includes a gas supply inlet. Pressure monitoring means may be associated with said enclosure for monitoring the pressure of gas therein. The apparatus may include means, for example said data processing unit, for storing information relating to the gas pressure within the enclosure, suitably relative to time. Said date processing unit may be arranged to adjust the gas pressure within the enclosure in a predetermined manner. Thus, by providing a gas control means as described, the gas pressure to which materials in said regions is/are subjected may be accurately controlled and monitored.

Preferably, each said temperature monitoring means is operatively connected to a recording device, for example said data processing unit described above, for recording information relating to temperature sensed by said temperature monitoring means. Said data processing unit may be arranged to record information relating to temperature relative to time, for example the time elapsed from the start of a particular experiment undertaken using the apparatus. Preferably, said recording device is arranged such that a temperature (or a parameter related to temperature) versus time profile can be generated for each material of said array.

Suitably, the temperature level measured by each temperature monitoring means is arranged to be compared to a reference temperature, measured by suitable means. The reference temperature may for example be the temperature of a wall which defines a region for accommodating a material to be monitored. Information relating to the reference temperature is preferably arranged to be communicated to a processing unit which is also arranged to receive information relating to temperature measured by said respective temperature monitoring means. The reference temperature could be measured by further temperature monitoring means of a type described herein. A respective said further temperature monitoring means may be associated with each respective region in said array for accommodating material.

Each said temperature monitoring means is preferably arranged to produce a digital and/or numerical value which is suitably recorded by said recording device. In one embodiment, the digital and/or numerical value preferably represents a measure of resistance in Ohms.

Preferably each of said temperature monitoring means is arranged to produce a continuous, uninterrupted output of information relating to the temperature of material monitored. It is not necessary, however, to record the entirety of the output of each temperature monitoring means. Accordingly, the apparatus may include a sampling device, preferably a multiplexer, for sampling the output of the temperature monitoring means at intervals, preferably predetermined intervals, and, preferably, the information sampled is recorded by said recording device described. For example, the sampling device may be arranged to sample each said temperature monitoring means at least once every 10 seconds, preferably at least once every 5 seconds, more preferably at least once every 3 seconds, especially at least once every 2 seconds. In the most preferred embodiment, sampling is undertaken at least once per second.

Preferably, the apparatus is arranged to monitor a plurality of temperature ranges substantially concurrently. To this end, the apparatus is preferably arranged such that each temperature monitoring means in said array can monitor at least two temperature ranges. Preferably at least three, more preferably at least four, especially at least five temperature ranges can be monitored as described. To achieve the aforesaid, one or more respective resistors are preferably connected across each temperature monitoring means to thereby affect the sensitivity thereof. Thus, the apparatus may be arranged so that one temperature range monitored has a width of less than 10° C., preferably less than 7° C.; and another temperature range monitored may have a width of greater than 10° C., preferably greater than 15° C.

Said regions for accommodating materials to be monitored are preferably substantially identical to one another. Said regions may have a width of at least 1 mm, preferably at least 2 mm, more preferably at least 3 mm, especially at least 4 mm. The width may be less than 5 cm, is suitably less than 4 cm, is preferably less 3 cm, is more preferably less than 2 cm and, especially, is 1 cm or less. Where said regions are defined by receptacles, said receptacles preferably have a height which is greater than the maximum width, suitably by a factor of at least 2, preferably at least 3, more preferably at least 5.

Each of said regions for accommodating material to be monitored is preferably thermally insulated, more preferably substantially thermal isolated, from each other region, in said array, for accommodating material to be monitored.

Preferably, said temperature monitoring means are either thermocouples or thermistors. Each temperature monitoring means is preferably a thermistor.

Preferred thermistors include lead wires in the range 10 to 300 mm, preferably 20-200 mm, especially 30-150 mm.

Preferred thermistors have a Dissipation Constant of at least 0.4 mW/° C., preferably at least 0.6 mW/° C., more preferably at least 0.8 mW/° C. The Dissipation Constant may be less than 5 mW/° C., preferably less than 3 mW/° C., more preferably less than 1.0 mW/° C.

Said temperature monitoring means, especially thermistors as described, may have an accuracy of at least 0.01° C., suitably at least 0.005° C., preferably at least 0.001° C., more preferably at least 0.0005° C. In preferred embodiments accuracy of the order of 10⁻⁴° C. may be achieved.

According to a second aspect of the invention, there is provided a method of monitoring a thermal event, the method comprising:

(a) arranging material to be monitored in respective regions, for example receptacles, for accommodating material to be monitored;

(b) monitoring material in each region using respective temperature monitoring means, a respective one of which is associated with each region.

The method may be used to monitor any process, for example a physical or chemical process where there is a heat change. For example, the effectiveness of catalysts may be monitored. In this case, a catalyst (or a precursor) is arranged in said respective regions and a reagent or reagents whose reaction may be mediated by the catalyst is/are brought into contact therewith. In one embodiment, a polymerisation reaction may be monitored in which case a monomer gas may be brought into contact with the catalyst. Suitably, the pressure of the monomer gas is controlled and this parameter may be varied to assess the effect of variation on the thermal event monitored and, therefore, the effectiveness of the catalyst in the polymerisation.

The method may be used in situations wherein a gas is not caused to react with material in said respective regions. For example, a liquid reagent may be brought into contact with material in said respective regions and then the combination monitored. For example, the method may be used to monitor crystallisations, polymorphs, salts, hydrates or solvates. In other situations, the method may be used to monitor a formulation for example to assess its stability over time.

Preferably, in the method, each temperature monitoring means contacts material disposed in a respective region, suitably so that heat passes from said material to said temperature monitoring means by conduction.

Preferably, the method includes controlling the temperature of the atmosphere around said regions in which material is monitored. Preferably, said temperature is kept substantially constant during a first experiment using said method. In a second experiment using said method, which suitably monitors the same materials as in said first experiment, the method may involve keeping said temperature constant but at a different level compared to said first experiment. In one embodiment, the temperature of the atmosphere may be varied during a particular experiment, suitably in a predetermined and/or measured manner.

The method preferably includes communicating information relating to temperature from each temperature monitoring means to a data processing unit. The method preferably includes storing information relating to the time when information relating to temperature is sampled from materials in said regions. Thus, the method preferably involves constructing a temperature (or a parameter related thereto) versus time profile for material in each said region. The profile is preferably provided as a digital output.

The method may include comparing information relating to temperature perceived by respective monitoring means to a reference temperature and using the difference in the temperature values to yield information relevant to energy associated with said thermal event.

Preferably, the method involves said temperature monitoring means being operated to substantially continuously monitor temperature of the materials in said regions. Thus, said temperature monitoring means preferably give a continuous output. The method preferably involves sampling the output from each temperature monitoring means at intervals using a sampling device.

The method preferably involves each temperature monitoring means monitoring a plurality of temperature ranges concurrently.

The method preferably involves monitoring temperature changes during thermal events to an accuracy of at least 0.01° C.

After a thermal event has been monitored in the method, material in said regions may be removed and analysed.

The method may advantageously involve using data captured to ascertain kinetic information, where reactions are monitored in the method.

The method preferably involves measuring a temperature change, rather than establishing an absolute temperature value for material monitored at any particular moment in time.

According to a third aspect of the invention, there is provided a collocation comprising an array of materials resulting from use of apparatus according to said first aspect or from said method according to said second aspect in combination with data which defines temperature (or another parameter relating thereto) versus time profiles for said materials which profiles are established using said apparatus or method.

According to a fourth aspect of the invention, there is provided the use of apparatus according to said first aspect for monitoring thermal events.

Any feature of any aspect of any invention or embodiment described herein may be combined with any feature of any aspect of any other invention or embodiment described herein.

Specific embodiments of the invention will now be described, by way of example, with reference to the accompanying drawings, in which:

FIG. 1 provides schematic temperature versus time profiles for catalyst types (A), (B) and (C);

FIG. 2 is a schematic side view of an apparatus for monitoring a thermal event;

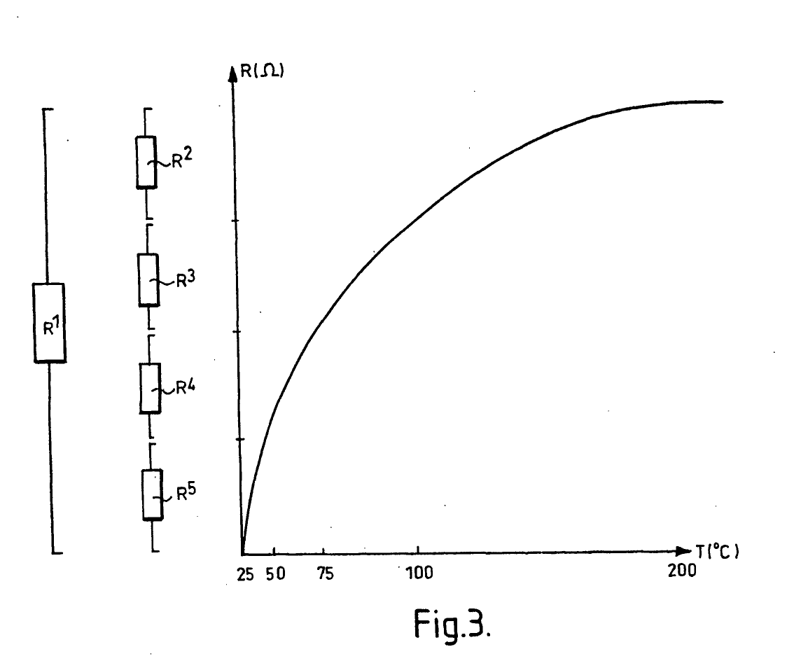

FIG. 3 is a schematic representation of a resistance versus temperature profile.

Referring to FIG. 2, the apparatus for monitoring a thermal event 2 comprises an array of receptacles 4 for containing material to be monitored. Suitably, the array may include ninety-six identical receptacles (only eight of which are shown in FIG. 1) although there is no practical upper or lower limit for the number of receptacles of an apparatus. The receptacles 4 are thermally isolated from one another to substantially prevent passage of heat therebetween.

A respective thermistor 6 is provided in each receptacle 4 and each thermistor is linked via a respective line 8 to a central control unit 10. Each thermistor is suspended in its receptacle such that it directly contacts materials within the receptacle so that heat may pass from the materials to the thermistor by conduction and, additionally, each thermistor is thermally insulated from the walls of the receptacle with which it is associated.

The thermistors may be supported on a framework and immovably fixed within the respective receptacles. Preferably, however, the thermistors are movable into and out of the receptacles, thereby to facilitate input of materials into the receptacles. To this end, a frame may support the thermistors and may be movable, for example pivotable for moving the thermistors into and out of the receptacles.

In one embodiment, the temperature of the receptacles is suitably monitored, for example by respective thermistors associated with each receptacle, in addition to monitoring of materials within the receptacles using thermistors 6. Thus, the apparatus may be arranged to measure minute changes in temperature of materials within the receptacles.

Respective lines 8 include means for powering the thermistors and also for relaying information relating to the resistance of the thermistors to the control unit 10. It will be appreciated that information relating to the resistance can be converted to information relating to temperature of materials within the receptacles.

Many different types of thermistors are suitable for use in the apparatus 2. An example of a suitable thermistor is available from Betatherm (Trade Mark) of www.betatherm.com and is referred to as a BetaCurve Interchargeable Thermistor Series II. Such a thermistor comprises 30 AWG silver plated copper lead wires with etched TFE Teflon insulation. The length of the lead wires is about 70-80 mm, enabling the thermistor to be readily mounted in receptacles 4. The thermistor has a DC (Dissipation Constant) of 0.85 mW/° C., making it suitable for monitoring a wide range of different thermal events.

The control unit 10 includes a five channel chip, into which the thermistors are wired, having a 0-5000 response. Five different resistors are connected across the thermistors and arranged to enable different temperature ranges to be monitored using the apparatus. This is illustrated schematically in FIG. 2. Referring to the figure, R¹ is selected so that, when connected across a thermistor, the thermistor measures a broad temperature range of 25 to 200° C. which means the resolution will be (200−25)/5000=0.35° C. Thus, monitoring across R¹ provides a very broad temperature profile. This can, however, be focussed by measuring across any of the other resistors R²-R⁵. For example, across R⁵, the resolution will be (50−25)/5000=0.005° C. and it can be focussed similarly in other temperature ranges. If desired, a resistor may be arranged to focus on an even narrower temperature range. Thus, the apparatus enables a multiplicity, for example five temperature ranges to be monitored concurrently.

The control unit 10 includes a multiplexing device to which the thermistors are connected. The multiplexing device allows the temperature perceived by each thermistor to be recorded every 1/96^{th} of a second, so that a substantially continuous temperature/time profile for thermal events taking place in each receptacle 4 can be accurately digitally recorded.

The array of receptacles is suitably provided within a box 12 which is arranged to thermally isolate internal regions thereof from the outside. The box 12 may be an autoclave whereby the temperature within the box may be kept constant during one series of experiments, but may be increased or decreased for another series of experiments. The box may include a gas supply port 14 for delivery of a reagent (or other gas) into the box.

A robot may be associated with the box for delivery of materials to the receptacles 4.

The apparatus may be used for monitoring a range of thermal events. In general terms, the apparatus may be used to monitor any process, such as a physical or chemical process, that involves a heat change (−ΔH or +ΔH). In some embodiments, monitoring may be undertaken at a constant temperature; or, alternatively, temperature could be raised or lowered and any heat changes monitored.

Examples of thermal events that may be monitored using the apparatus include the following:

1. Assessing effectiveness of catalysts—the apparatus may be used for such an assessment on the basis that the effectiveness of a catalyst may be related to the heat change occurring during a catalysed reaction. For example, catalysts for use in the polymerisation of ethylene (or other alkenes) may be assessed. In this case, an array of catalysts to be assessed may be arranged in respective receptacles 4. Suitably, a robot is used to deliver the catalysts or components thereof to the receptacles in a predetermined manner. Then, the temperature within the box 12 may be set at a predetermined level and, when a steady state temperature has been reached, ethylene may be input into the box 12, via supply port 14, at a predetermined pressure. The ethylene will polymerise on the catalysts within the receptacles and the thermistors 6 therewithin will monitor any temperature changes and relay information relating to same to control unit 10. At the end of an experiment, the polyethylene formed may be analysed, together with the detailed thermal information captured by the thermistors and a temperature versus time profile (effectively providing an activity versus time profile) may be analysed to assess each catalyst's effectiveness.

The experiment may be repeated using the same catalysts, but using different box temperatures and/or ethylene pressures. Additionally, the box temperature may be adjusted during a particular experiment, to assess the effect of this.

2. Monitoring Crystallisations—a material to be assessed is placed in each receptacle 4 together with potential crystallisation solvents. The box temperature is selected and then the thermistors are used to monitor any temperature changes of the materials.

The experiment may be repeated using different fixed box temperatures or the box temperature may be varied during an experiment.

Information captured by the thermistors may be used to assess the crystallisability of the material under the conditions used.

3. Investigating Polymorphs—the existence and/or formation of polymorphs may be investigated in a similar manner to that described in point 2 above. By constructing temperature versus time profiles for potential polymorphic materials assessed over a range of conditions (e.g. different solvents and temperature profiles) factors which affect polymorph formation may be determined.

4. Investigating Salts—the formation and/or stability of salts, for example salts of active pharmaceutical materials, may be investigated in a similar manner to that described in points 2 and/or 3 except that a material to be assessed, a material which may form a salt with the material to be assessed and/or a solvent may be arranged within receptacles 4 and then temperature versus time profiles may be constructed. Such profiles may provide information on ease of formation and/or stability of the salts.

5. Investigating hydration and/or solvation—in a manner analogous to the procedures described in points 2 to 4, the hydration and/or solvation of materials may be investigated.

6. Assessing formulation stability—the stability of any type of formulation, for example an agrochemical, pharmaceutical, paint or other formulation may be assessed by arranging sample formulations in the receptacles, subjecting the formulations to predetermined conditions (e.g. temperature, pressures, different gases etc) and constructing temperature versus time profiles. Even small thermal events may indicate that a formulation has some instability (e.g. slow crystal growth) and may change detrimentally at some future date. The assessment may, therefore, aid an early assessment of which formulations are likely to be most stable and which are not.

In one embodiment, materials may be hazard-tested using the apparatus. In this case, the heat stability may be assessed by raising the temperature within the box 12 over a period of time and monitoring the materials.

7. Turbidity—turbidity changes of formulations may also be investigated in a manner analogous to the methods described above.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. Apparatus for monitoring thermal events, the apparatus comprising an array of regions for accommodating materials to be monitored, wherein a respective temperature monitoring means is associated with each region.

2. Apparatus according to claim 1, wherein said regions comprise receptacles.

3. Apparatus according to claim 2, wherein each said temperature monitoring means is arranged to be positioned at least partially within a liquid containing region of a respective said receptacle.

4. Apparatus according to any preceding claim, wherein each said temperature monitoring means is arranged to contact materials to be monitored in a respective said region.

5. Apparatus according to any preceding claim, wherein each said temperature monitoring means is arranged for the passage of heat from material accommodated in a said region by conduction.

6. Apparatus according to any preceding claim, wherein each said temperature monitoring means is arranged to be moved between first and second positions wherein, when in said first position, said temperature monitoring means are arranged to monitor temperature of material within said regions and, when in said second position, said temperature monitoring means are spaced further away from said regions and represent a non-working position wherein temperature is not monitored.

7. Apparatus according to any preceding claim, wherein said array of regions includes at least ten members.

8. Apparatus according to any preceding claim, wherein said array of regions is arranged within an enclosure and said apparatus includes temperature control means for controlling the temperature within the enclosure.

9. Apparatus according to claim 8, wherein there is provided a means for storing information relating to the temperature within the enclosure relative to time.

10. Apparatus according to claim 8 or claim 9, wherein a data processing unit is arranged to adjust the temperature within the enclosure in a predetermined manner.

11. Apparatus according to any of claims 8 to 10, which includes gas control means for controlling the supply of a gas into said enclosure.

12. Apparatus according to any preceding claim, wherein each temperature monitoring means is operatively connected to a recording device for recording information relating to temperature sensed by said temperature monitoring means.

13. Apparatus according to claim 12, wherein said recording device is arranged to record information relating to temperature relative to time.

14. Apparatus according to claim 12 or claim 13, wherein said recording device is arranged such that a temperature versus time profile can be generated for each material of said array.

15. Apparatus according to any preceding claim, wherein the temperature level measured by each temperature monitoring means is arranged to be compared to a reference temperature measured by suitable means.

16. Apparatus according to any preceding claim, wherein each said temperature monitoring means is arranged to produce a digital and/or numerical value which represents a measure of resistance in Ohms.

17. Apparatus according to any preceding claim, wherein each of said temperature monitoring means is arranged to produce a continuous uninterrupted output of information relating to the temperature of material monitored.

18. Apparatus according to any preceding claim, which includes a sampling device for sampling the output of the temperature monitoring means at intervals.

19. Apparatus according to any preceding claim, the apparatus being arranged to monitor a plurality of temperature ranges substantially concurrently.

20. Apparatus according to any preceding claim, wherein each temperature monitoring means in said array can monitor at least two temperature ranges.

21. Apparatus according to any preceding claim, wherein each of said regions for accommodating material to be monitored is thermally isolated from each other region for accommodating material to be monitored in said array.

22. Apparatus according to any preceding claim, wherein said temperature monitoring means are either thermocouples or thermistors.

23. Apparatus according to any preceding claim, wherein each temperature monitoring means is a thermistor.

24. Apparatus according to any preceding claim, wherein said temperature monitoring means have an accuracy of at least 0.01° C.

25. Apparatus according to any preceding claim, wherein said temperature monitoring means have an accuracy of at least 0.001° C.

26. A method of monitoring a thermal event, the method comprising:
a) arranging material to be monitored in respective regions for accommodating material to be monitored;
b) monitoring material in each region using respective temperature monitoring means, a respective one of which is associated with each region.

27. A method according to claim 26, wherein a catalyst (or a precursor thereof) is arranged in said respective regions and a reagent or reagents whose reaction may be mediated by the catalyst is/are brought into contact therewith.

28. A method according to claim 26 or claim 27, which is used to monitor crystallisations, polymorphs, salts, hydrates or solvates.

29. A method according to any of claims 26 to 28, the method involving constructing a temperature (or a parameter related thereto) versus time profile for material in each said region.

30. A method according to any of claims 26 to 29, which involves measuring a temperature change, rather than establishing an absolute temperature value for material monitored at any particular moment in time.

31. A collocation comprising an array of materials resulting from use of apparatus according to any of claims 1 to 25 or from said method according to any of claims 26 to 30 in combination with data which defines temperature (or another parameter relating thereto) versus time profiles for said materials which profiles are established using said apparatus or method.

32. The use of apparatus according to any of claims 1 to 25 for monitoring thermal events.
